(19) United States
(12) Patent Application Publication
(10) Pub. No.: US 2005/0262396 A1
(43) Pub. Date: Nov. 24, 2005

(54) APPARATUS AND METHOD FOR AUTOMATED TEST SETUP

(75) Inventors: Joel D. Woodward, Colorado Springs, CO (US); Adrian M. Hernandez, Colorado Springs, CO (US); Mason B. Samuels, Colorado Springs, CO (US); James B. Stewart III., Colorado Springs, CO (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(73) Assignee: AGILENT TECHNOLOGIES, INC, Loveland, CO (US)

(21) Appl. No.: 10/904,137

(22) Filed: Oct. 26, 2004

Related U.S. Application Data
(63) Continuation-in-part of application No. 10/923,460, filed on Aug. 20, 2004.
(60) Provisional application No. 60/565,308, filed on Apr. 26, 2004.

(51) Int. Cl. G06F 11/00

(52) U.S. Cl. 714/30

(57) ABSTRACT

Apparatus and methods for setting up a test instrument to perform measurements on a circuit having a plurality of signal applied to a plurality of output pins. Configuration parameters including an identification of the output pins are retrieved and the test instrument is configured to interface with the output pins based on the configuration parameters. A list of output pins and a list of input lines associated with the test instrument are graphically displaying on a screen associated with the test instrument. Interacting with the graphical display, the user then associates each output pin with an input line to which each output pin is connected.

### CROSS REFERENCE TO RELATED APPLICATIONS

The present application claims priority under 35 U.S.C. §120 to U.S. Provisional Patent Application Ser. No. 60/565,308, filed Apr. 26, 2004 entitled DYNAMIC IN-CIRCUIT PROBING OF FIELD PROGRAMMABLE GATE ARRAYS. The present application also claims priority under 35 U.S.C. §120 to U.S. patent application Ser. No. 10/923,460 filed Aug. 20, 2004 entitled APPARATUS AND METHOD FOR DYNAMIC IN-CIRCUIT PROBING OF FIELD PROGRAMMABLE GATE ARRAYS, which in turn claims priority to the '308 provisional patent application.

### BACKGROUND OF THE INVENTION

Modern integrated systems, such as systems on a chip (SOCs); field programmable gate arrays (FPGAs) and application specific integrated circuits (ASICs) often contain features designed to facilitate in-circuit testing. The normal procedure, when doing in-circuit testing on large circuits such as field programmable gate arrays (FPGAs), is to feed the circuit real world stimuli throughout the operating range and monitor the resultant signal at various points throughout the circuit. This type of testing is commonly called shmoo testing.

Test instruments, like oscilloscopes and logic analyzers, are important tools used for in-circuit test. Many digital designers are accustomed to bringing up their prototype boards using a logic analyzer as a debug aid. They use the logic analyzer to help uncover integration issues as well as design errors. To observe the behavior of the system, the designer probes various buses and chips in an attempt isolate the root cause of the problem. It is through this probing and re-probing of various components, that enough information may be gathered to properly assess the factors leading to the problem. With this information it is possible for the engineering team to understand the error and formulate a solution.

When an engineer needs to access internal probe points, he first changes the design and routing out the set of signals to an output point, typically a set of output pins. These output pins are generally placed on a PC board where a probe associated with a test instrumentation can capture the signals. The location is typically a connector, such as a berg strip, samtec component, or mictor component, but may be a connectorless footprint (i.e. soft touch). Each probing type has a special cable that mates to the connector on the PC board and routes these signals to the logic analyzer. An alternative is to use flying leads capable of attaching directly to the output leads of a chip. Next, the engineer must set up a logic analyzer to capture signals from the output point.

Setting up a logic analyzer for probing signals from ASICs or FPGAs typically takes several hours. To set up a logic analyzer, the engineer must first manually identify an output pin associated with each internal signal. Secondly, the engineer must manually identify a probe pin associated with each output pin. Next, the logic analysis pod and channel associated with each probe pin is manually identified. Finally, the best sampling point for each channel is determined and the instrument input channel sampling point is adjusted manually to compensate for channel-to-channel skew.

There are several disadvantages with the current method. First the process is time consuming. Each signal is handled independently. The process is manual and must be done for each signal, one at a time. So, when the number of signals increases, the amount of time for the setup increases. Designers typically manage this translation by writing down pieces of information on paper and manually entering the channel assignment and signal name on the logic analyzer setup menu. This process can take several hours and must be made each time a user sets up a new measurement. Second, the process is tedious and error-prone. Examples of errors include: miss-identification of signal routed out to a specific FPGA pin; the PC board layout may be mischaracterized; incorrect specification a channel or pod in the logic analyzer; and a signal may be incorrectly labeled or spelled in the logic analyzer menu. Each of these problems is exacerbated when testing a system that employs multiplexed banks of output signals as disclosed in co-pending U.S. application Ser. No.: 10/923,460 filed Aug. 20, 2004, incorporated herein by reference.

The present inventors have recognized a need for apparatus and methods to reduce the time required to set up a logic analyzer (or other type of test equipment) while reducing errors associated with current methods.

### BRIEF DESCRIPTION OF THE DRAWINGS

An understanding of the present invention can be gained from the following detailed description of the invention, taken in conjunction with the accompanying drawings of which:

FIG. 1 is a block diagram of a dynamic probe in accordance with an embodiment of the present invention.

FIG. 2 is a block diagram of a state trace core, for use in a dynamic probe, in accordance with an embodiment of the present invention.

FIG. 3 is a block diagram of a timing trace core, for use in a dynamic probe, in accordance with an embodiment of the present invention.

FIG. 4 is a block diagram of a logic analyzer 400 in accordance with a preferred embodiment of the present invention.

FIG. 5 is a flow chart describing a method of preparing a logic analyzer for a test session.

FIG. 6 is a screen shot of a graphical display produced by software in accordance with a preferred embodiment of the present invention.

FIG. 7 is a screen shot of a graphical display related to the cable connection button shown in FIG. 6.

FIG. 8 is a screen shot of a graphical display related to the configure device button shown in FIG. 6.

FIG. 9 is a screen shot of a graphical display related to the pin mapping button shown in FIG. 6.

FIG. 10 is a screen shot of a graphical display related to the properties button shown in FIG. 6.

FIG. 11 is a screen shot of a graphical display associated with the selection of cores and banks.

FIG. 12 is a screen shot of a graphical display produced by software in accordance with a preferred embodiment of the present invention.

FIG. 13 is a screen shot of a graphical display related to the trim bus/signal names button shown in FIG. 11.

FIG. 14 is a block diagram of a state trace core for use in a dynamic probe, in accordance with an embodiment of the present invention.

FIG. 15 is a block diagram of a timing trace core for use in a dynamic probe, in accordance with an embodiment of the present invention.

FIGS. 16a through 16f are flow charts of a method in accordance with an embodiment of the present invention.

FIG. 17 is a block diagram of a circuit used to output a test signal on a selected pin of a device under test.

FIG. 18 is a block diagram of a circuit used to output a test signal on a selected pin of a device under test.

### DETAILED DESCRIPTION

Reference will now be made in detail to the present invention, examples of which are illustrated in the accompanying drawings, wherein like reference numerals refer to like elements throughout. The detailed description which follows presents methods that may be embodied by routines and symbolic representations of operations of data bits within a computer readable medium, associated processors, logic analyzers, digital storage oscilloscopes, general purpose personal computers configured with data acquisition cards and the like. A method is here, and generally, conceived to be a sequence of steps or actions leading to a desired result, and as such, encompasses such terms of art as “routine,” “program,” “objects,” “functions,” “subroutines,” and “procedures.” These descriptions and representations are the means used by those skilled in the art effectively convey the substance of their work to others skilled in the art.

The apparatus and methods of the present invention will be described with respect to implementation on a logic analyzer, but the methods recited herein may operate on a general purpose computer or other network device selectively activated or reconfigured by a routine stored in the computer and interface with the necessary signal processing capabilities. More to the point, the methods presented herein are not inherently related to any particular device, rather, various devices may be used with routines in accordance with the teachings herein. Machines that may perform the functions of the present invention include those manufactured by such companies as AGILENT TECHNOLOGIES, INC., HEWLETT PACKARD, and TEKTRONIX, INC. as well as other manufacturers of test and measurement equipment.

With respect to the software described herein, those of ordinary skill in the art will recognize that there exist a variety of platforms and languages for creating software for performing the procedures outlined herein. The embodiments of the present invention can be implemented using any of a number of varieties of C, however, those of ordinary skill in the art also recognize that the choice of the exact platform and language is often dictated by the specifics of the actual system constructed, such that what may work for one type of system may not be efficient on another system.

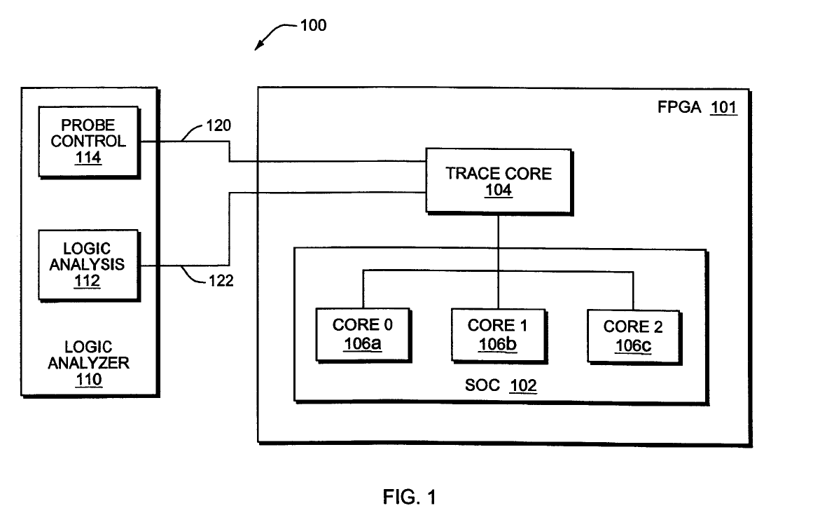

The present invention will be described with respect to implementation on systems as described in co-pending U.S. application Ser. No.: 10/923,460, incorporated herein by reference. To facilitate an understanding of the present invention as applied to such systems, FIGS. 1 through 3 and the following associated discussion is provided. However, those of ordinary skill in the art will recognize that the present invention is also applicable to a variety of circuits, including FPGAs and ASICS that do not implement the multiplexed output described therein.

FIG. 1 is a block diagram of a dynamic probe system 100 in accordance with an embodiment of the present invention. The dynamic probe system 100, simplifies debugging on, for example, FPGAs and Systems on a Chip (SOCs). The dynamic probe system 100 improves observability facilitating in-circuit debug. While the dynamic probe system 100 is designed for the SOC flow (allowing all existing tools, design procedures, and HDL for the SOC is to be kept in tact) the present invention is not limited to SOCs but may be used in a variety of environments both on and off FPGAs.

The dynamic probe system 100 generally comprises a logic analyzer 110 connected to one or more trace cores 104 inside a FPGA 101. The trace core 104 comprises a dedicated debug core that routes internal signals off the FPGA 101 to the logic analyzer 110. The trace core 104 connects internal signals from one or more cores 106n in the SOC 102 (or more generally the circuit under test) to output pins probed by a logic analyzer 110. The logic analyzer 110 and the FPGA 101 are connected by two busses 120 and 122.

Data signals from the cores 106n are obtained off spare pins on the FPGA 101 over a data signal bus 122. The data signal bus 122 typically, but not necessarily, comprises a regular probing connection associated with the logic analyzer 110. As the number of spare pins is usually are fewer than the number of signals that need probing, the trace core 104 switches the signal output on the pins to provide selectable banks of signals. The term signal and channel are used interchangeably herein.

The logic analyzer 110 generally comprises a logic analysis portion 112 and a probe control portion 114. The logic analyzer 110 can be based on, for example, an AGILENT 16903A. The logic analysis portion 112 generally comprises a known logic analyzer while the probe control portion 114 generally comprises additional software running under the operating system attendant to the logic analysis portion 112. The probe control portion 114 generally monitors and controls the trace core 104 using a serial communication bus 120 operating in accordance with any of a number of serial communication standards, such as IEEE 1149.1—also known as JTAG.

The dynamic probe system 100 can be configured for state or timing measurements. State measurements use a single sampling clock for all the inputs to the trace core. The sampling clock for the state core comes from within the SOC 102. Timing measurements do not use a design supplied sampling clock. Instead the trace data is sampled on the logic analyzer 110 using a clock generated by the logic analyzer 110. Thus, with a trace core 104 configured for timing measurements (a “timing trace core”) it is possible to inspect glitches in the SOC 102, whereas a trace core 104 configured for state measurements (a “state trace core”) is intended for synchronous measurements.

While a variety of FGPA tools exist that could be modified to add the trace core 104, the following discussion will be limited to the creation and addition using ChipScope tools. The trace core 104 may be added into an FPGA 101 by two methods, instantiation and insertion. Adding the trace core 104 by instantiation requires the SOC designer to modify their HDL and instantiate the trace core 104 into their design. The instantiated core is actually a black box design that will be connected during final FPGA place and route. An alternate method for adding trace core 104 is insertion using Xilinx's ChipScope Core Inserter tool. This tool takes a synthesized design, such as an SOC, and adds the trace core 104 using the design EDIF file. In this case the SOC HDL is not modified and the trace core 104 may be sized and connected using this core insertion tool.

The XILINX software outputs a “.cdc” file for each core inserted. A .cdc file contains information the describing the associated core, the associated EDIF files where signal names for each selectable bank may be found, and the selected FPGA I/O standards. Table 1 contains an example of a CDC file.

```
TABLE 1
#ChipScope Core Inserter Project File Version 3.0
#Tue May 04 09:57:58 MDT 2004
Project.device.designInputFile=x\:\\ah2285_atc\\atc_ip_hw\\
atc2_eagle\\ip
    \\dynamic_probe_qa_designs\\designs\\fe_design\\
    v7demo\\demobd
    \\synpro\\demo\\demo.edf
Project.device.designOutputFile=x\:\\ah2285_atc\\atc_ip_hw\\
atc2_eagle\\ip
    \\dynamic_probe_qa_designs\\designs\\fe_design\\v7demo\\demobd
    \\synpro\\demo\\_ngo\\demo.ngo
Project.device.deviceFamily=2
Project.device.enableRPMs=true
Project.device.outputDirectory=x\:\\ah2285_atc\\atc_ip_hw\\
atc2_eagle\\ip
    \\dynamic_probe_qa_designs\\designs\\fe_design\\v7demo\\demobd
    \\synpro\\demo\\_ngo
Project.device.useSRL16=true
Project.filter.dimension=5
Project.filter<0>=
Project.filter<1>=*state*
Project.filter<2>=*tid*
Project.filter<3>=*ver*
Project.filter<4>=*clk*
Project.icon.boundaryScanChain=0
Project.icon.disableBUFGInsertion=true
Project.icon.enableExtTriggerIn=false
Project.icon.enableExtTriggerOut=false
Project.icon.triggerInPinName=
Project.icon.triggerOutPinName=
Project.unit.dimension=1
```

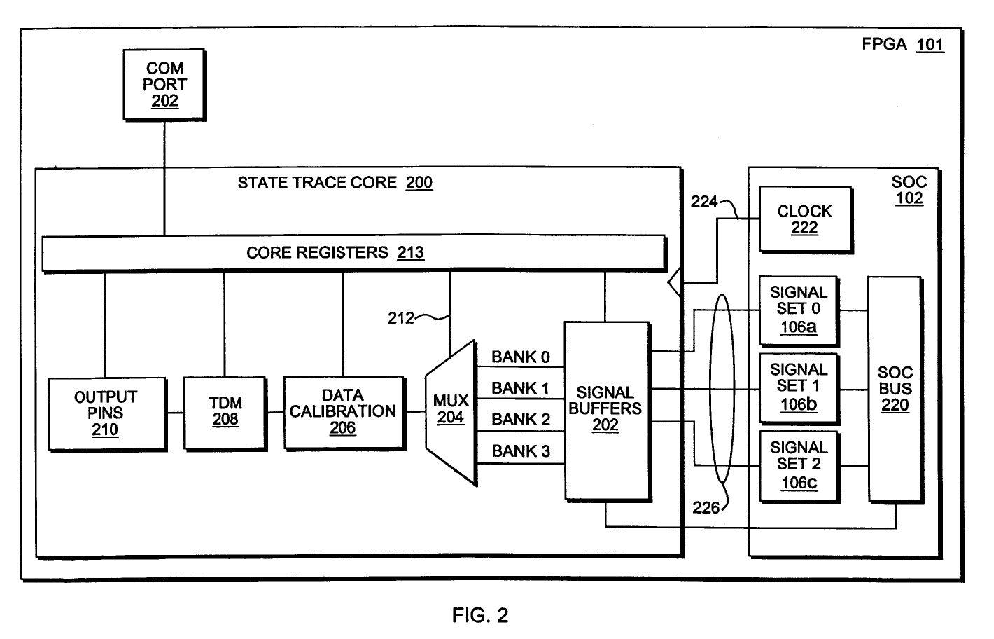

FIG. 2 is a block diagram of a state trace core 200 (also referred to as the core 200), for use in a dynamic probe 100, in accordance with an embodiment of the present invention. The core 200 generally comprises a multiplexer (mux) 204, a data calibration unit 206, a time division multiplexer (TDM) 208, output pins 210, along with a set of status and control registers collectively referred to as the core registers 213. The core registers 213 provide supervisory access to the logic analyzer 110. The mux 204, data calibration unit 206, TDM 208 and output pins 210 provide the physical link between probed signals on the SOC 102 and output pins going to the logic analyzer 110 (see FIG. 1). The physical link is synchronized to a sampling clock 222 supplied by the SOC 102 via channel 224.

A buffer 202 is situated between the mux 204 and the SOC 102. The buffer 202 generally comprises registers spanning the mux 204's inputs. The buffer 202 isolates the core 200 from the SOC 102. This isolation has two benefits. First, the mux 204 is not directly connected to the probed signal. The registers in the buffer 202 act as pipeline registers, adding only one additional load to the SOC signal and hiding any mux delay from it. The second benefit is that the registers in the buffer 202 can be disabled blocking signals from passing through to the rest of the core 200. The advantage here is that the core 200 can be turned off to save power, by simply disabling the buffer 202.

The mux 204 generally comprises a parallel multiplexer that directs groups, or banks, of signals from banks of inputs to a single bank of outputs. The number of input banks is configurable, and can be set to any desired size, for example from 2 banks to 2048 banks. With each additional bank, the number of observable signals increases. Each bank is connected to a signal set 106n in the SOC 102. Each signal in a set may be obtained from anywhere within the SOC 102, including a SOC bus 220. In FIG. 2, each line in the data signal connections 226 represents a bank of signals (or channels), e.g. a plurality of physical signal lines, for example 32 separate data sources. The number of signals in each signal set 106n may be defined by the designer, but (absent the use of TDM 208) generally corresponds to the number of output pins 210 dedicated for debugging.

The output of the mux 204 is switched using one or more select lines 212. Select lines 212 are driven by entries, set by the logic analyzer 110, in the core registers 213. The number of select lines 212 is dependent on the number of banks applied to the mux 204. For example if there are four banks (as shown in FIG. 2) then two select lines 212 would suffice. If eight banks are used then three select lines 212 would be needed.

The output of the mux 204 may be registered (not shown) to pipeline the mux logic and increase the performance of the core 200. The primary benefit is that the core 200 will not only run faster, but is less likely to interfere with the overall SOC timing budget.

At the end of the physical signal link between the SOC 102 and the core 200 are output pins 210. The output pins 210 generally comprise FPGA output buffers and pins/balls. It is to the output pins that the logic analyzer 110 will physically connect via the data channels 122. When the core 200 is created, the user specifies sets the number of data channels going to the logic analyzer 110—usually based on the available debug/spare pins in the FPGA 101. The core 200 has two types of channels going to the logic analyzer 110. The first channel type is a clock channel used to carry the clock signal from the clock 222 for use in sampling the trace data 214. The clock 222 generally comprises the trace core sample clock provided by the SOC 102. Typically only one pin is required for the clock channel 224. The second channel type is a data signal channel that carries the probed signals from the SOC 102 to the logic analyzer 110.

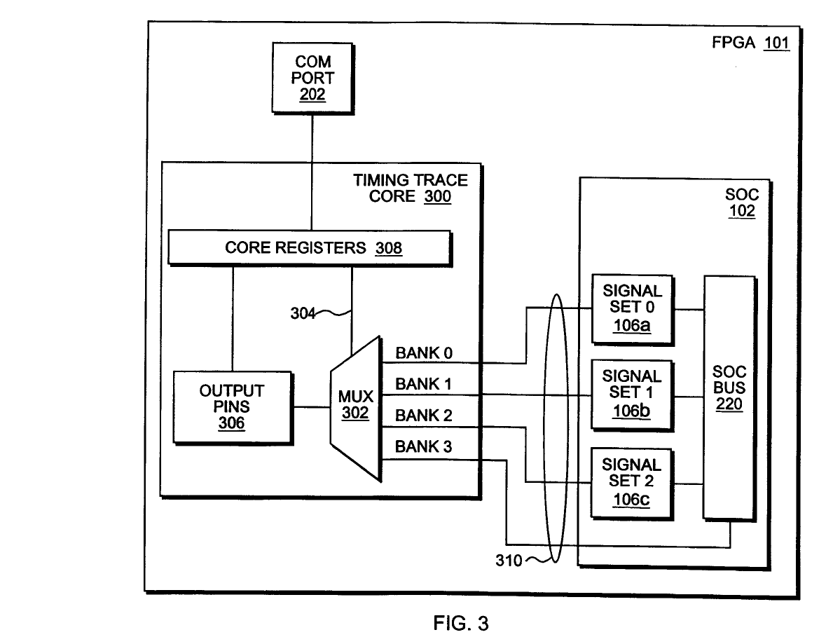

FIG. 3 is a block diagram of a timing trace core 300 (also referred to as the core 300), for use in a dynamic probe, in accordance with an embodiment of the present invention. The timing trace core generally comprises a multiplexer 302 (mux 302), output pins 306, and core registers 308. The mux 302 and the output pins 306 provide the physical link between internal signals and output pins. The physical link is asynchronous inside the core 300 and does not require a sampling clock from the SOC 102. Data on the physical link is captured by the logic analyzer 110 (see FIG. 1) using the logic analyzer's high speed sample clock. The registers 308 serve as the supervisory access for the logic analyzer 110.

The timing core mux 302 is similar to the state core mux 204 with the exclusion of the optional input and output registers. The timing core mux 302 directs banks of inputs to an output but does not register the inputs or the outputs allowing data going through the mux to be truly asynchronous. The number of mux input banks may range, for example, from 2 to 1024 and is set when the core 300 is created. In FIG. 3, each line in the data signal connections 310 represents a bank of signals, e.g. a plurality of physical signal lines (or channels), for example 32 separate data sources. The mux outputs are switched using select lines 304 connected to the registers 308. The inputs 302 to the mux 304 can come from anywhere inside the FPGA 101, allowing for a flexible connection of any signal in the SOC 102 to the timing trace core 300.

The output of the mux 302 goes to output pins 306. These pins represent the output buffers and pin/balls that connect to the logic analyzer 110. When the core 300 is created, the user specifies the number of pins, pin location, and output buffer standard for the core 300 outputs. The core 300 only has data signal channels as the clock channel from the SOC 102 is not used; however, the clock signal may be sent as a data signal. In general, the number of pins used by the core 300 is always equal to the number of data signal channels.

The path between the probed SOC signals and the output pins 306 is an unconstrained, false, path. This path is unconstrained in the FPGA 101 because the path from the probed SOC signal to the output pins 306 has no registers. Since no registers exist, FPGA place and route tools are unaware of any timing constraints. Therefore the FPGA tools will treat this as an unconstrained, false path. The effect of this behavior is that the timing of the probed signals will not affect the timing budget of the SOC 101.

The one draw back to the use of an unconstrained path is that the timing trace core data will be skewed. In this case, the deskew feature of the logic analyzer 110 can not be used. The solution to this is to either add constraints for the paths or to create an FPGA timing report and normalize the data captured by the logic analyzer 110. Resources are readily available for those of ordinary skill in the art to implement either solution.

The timing trace core 300 does not have a data calibration or TDM unit. With respect to the data calibration unit, the data may be manually deskewed (normalized) by the user using the logic analyzer over samples the inputs. TDM is not possible because the core 300 lacks an SOC sample clock from which to ship data a on its rising and falling edge. However, omitting these units reduces the size of the core 300.

The timing trace core 300 is intended to aid in measuring asynchronous events at a grand scale. The core 300 is not intended to aid in finding the precise setup and hold window of an individual flip-flop inside the FPGA 101. Instead, it is intended to aid in finding signals that toggle too early or late relative to other signals. The core 300 can also be used to detect glitches at the input pins, which may indicate problems at the PCB. The core 300 can aid in determining how long a signal remains high or low and at what rate it toggles. Finally, the core 300 can be used in multi-clock domain debug, allowing signals from two or more clock domains to be inspected simultaneously by the logic analyzer 110.

Logic Analyzer

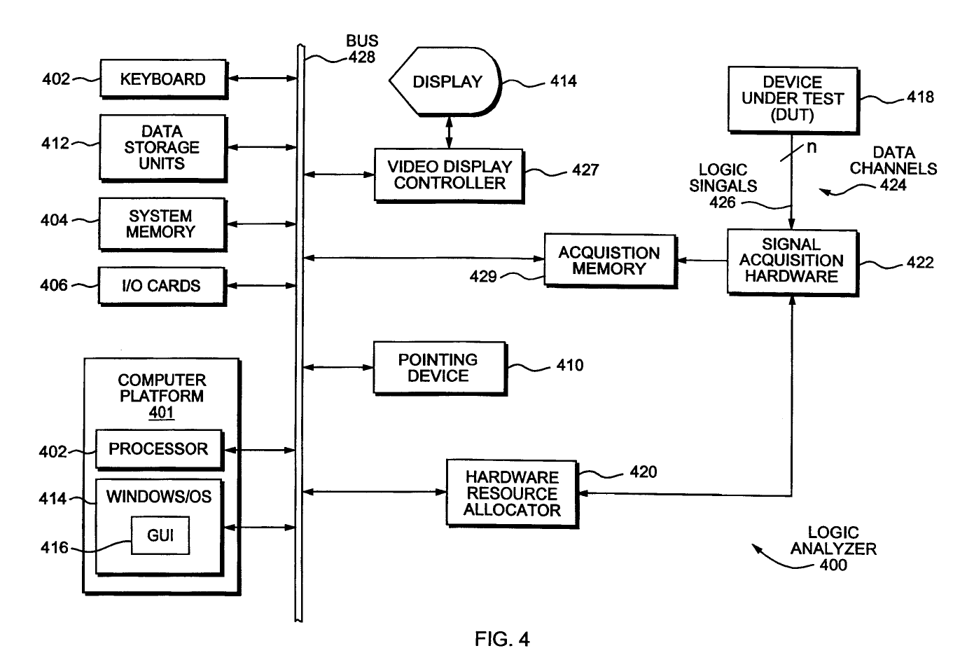

FIG. 4 is a block diagram of a logic analyzer 400 suitable for use with embodiments of the present invention. Logic analyzer 400 acquires, analyzes and displays a wide variety of signals generally in terms of the logic level of the signals versus time. In the illustrative analyzer shown in FIG. 4, logic analyzer 400 includes a general purpose computer system which is programmable using a high level computer programming language, and specially programmed, special purpose hardware for performing signal acquisition, analysis and display functions. The present invention may be implemented in other environments such as a stand alone logic analyzer or using special purpose program operating on an on-board processors, ASICs, firmware, hardware, or a combination thereof.

Logic analyzer 400 includes processor 402, system memory 404, input/output (I/O) cards 406, storage units 412 such as a hard disk drive, floppy disk drive, etc. Analyzer 400 may also include one or more user input/output devices such as keyboard 408, pointing devices 410 and display 414. System memory 404 is used for storage of software, including program instructions, computer-readable programs, and data. In a preferred embodiment, system memory 404 includes random access memory (RAM). Display 414 is a cathode ray display or LCD, and is logically or physically divided into an array of picture elements (pixels). Input/output (I/O) interface cards 406 may be modem cards, network interface cards, sound cards, and the like. Advantageously, at least one I/O interface card 406 may comprise a JTAG compliant interface, or an interface, such as a serial COM port or parallel printer port that can interface with a JTAG compliant cable.

Processor 402 is typically a commercially available processor, such as the Pentium microprocessor from INTEL CORPORATION, or PowerPC series microprocessors from IBM and MOTOROLA. Many other processors are also available. Such a processor executes a program referred to as an operating system 414, providing a graphical user interface (GUI) 416 and a windowing system, such as the various versions of the Windows operating systems, including WINDOWS XP from MICROSOFT CORPORATION or the Unix operating system available from many vendors such as SUN MICROSYSTEMS, INC., HEWLETT-PACKARD COMPANY and AT&T. Operating system 414 controls the execution of other computer programs such as software embodiments of the present invention, and provides scheduling, input-output control, file and data management, memory management, and communication control and related services. Processor 402 and operating system 414, generally define a computer platform shown by dashed block 401, for which application programs in high level programming languages may be written. The functional elements of logic analyzer 400 communicate with each other via system bus 428.

Signal acquisition module 422 contains circuitry and software that samples and digitizes logic signals 426 from a device under test 418 via data channels 424. In other words, signal acquisition module 422 receives and digitizes periodically-obtained samples of logic signals 426. The sampling time interval may be operator-specified or synchronized with a logic signal 426 received from device under test 418, such a clock signal generated by device under test 418. The sampled and digitized representation of logic signals 426 is stored temporarily for analysis by signal acquisition module 422.

A selected portion of the sampled logic signals 426 for subsequent storage and display is determined based on an operator-defined trigger sequence. A trigger sequence is specified generally by two parameters, a trigger definition that identifies the occurrences under which signal data is to be stored, and a trigger position that identifies the relative position of the occurrence defined by the trigger definition. A predetermined quantity of signal data occurring before and after the specified occurrence is stored in acquisition memory 429.

Logic analyzer 400 also includes a video display controller 427. Computer platform 401 drives video display controller 427 using standard windows applications program interfaces (API). The trigger sequence is defined through a measurement specification model presented in graphical user interface 416.

A hardware resource allocator 420 is interposed between signal acquisition hardware 422 and graphical user interface 416 on which a signal measurement specification model is presented to the user. Generally, the hardware resource allocator allocates and configures the requisite hardware resources and translates the measurement specification to hardware control data used by software drivers to program the signal acquisition hardware resources.

Automated Test Setup Software

The logic analyzer 400 operates under the control of software formulated pursuant to the selected operating system. The software described herein will be described with respect to the WINDOWS XP operating system. Further, the embodiments described herein will be described with respect to a device under test that utilizes the teachings set forth with respect to FIGS. 1 through 3, e.g. the use of a multiplexer controlled via a serial communication cable such as a JTAG compliant cable. Those of ordinary skill in the art will recognize that the present invention is applicable to other devices under test with and without additional communication cables.

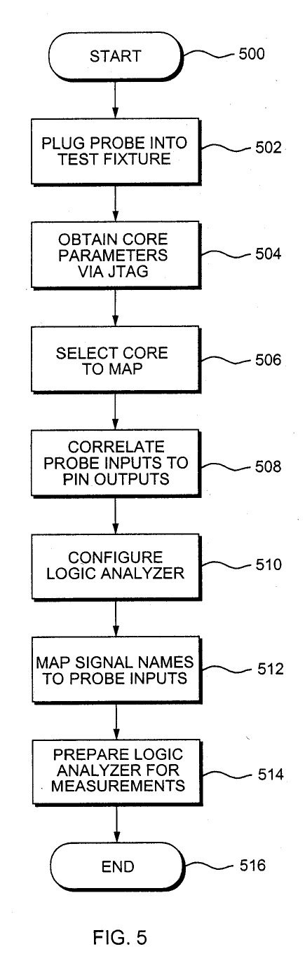

FIG. 5 is a flow chart describing a method of preparing a logic analyzer for a test session. The method starts in step 500. In step 502, the test engineer turns on the test equipment, e.g. a logic analyzer, and plugs a test fixture (i.e. a mictor, soft touch, samtec, or flying lead probes are examples) into the test points on the device under test, such as into a PC board supporting an ASIC or FPGA. Next in step 504, core configuration information is retrieved from the device under test, for example from the core registers via a JTAG communication link. Configuration information may include an identification of the cores that are available for interrogation; the number of pins used by the core and the output standard of the output pins. In step 506, a core is selected to map.

In step 508, the output pins on the device under test are mapped to input pins on the probe. This mapping may be performed utilizing a graphical user interface wherein the user is presented with a graphical representation of the output pins and asked to map the logic analyzer channels thereon. By moving each output pin to its associated channel, the user completes the mapping. In an improvement discussed hereinafter, a method for automatically identifying the correspondence between the output pins on the device under test and the channel on the logic analyzer is presented.

In step 510, the logic analyzer is configured to interface with the output pins of the device under test. For example, the probe is set to the output standard of the output pins, e.g. LVTTL, LVDS, and SSTL. Next, in step 512, signal names of signals applied to output pins on the device under test are mapped to channels on the logic analyzer allowing the signal names to be displayed with their corresponding channels on the logic analyzer display. In known methods, this has been performed manually with the user manually entering and assigning names to each channel in the logic analyzer. In accordance with the present invention, information about the signals applied to the output pins is retrieved and used to identify the channels on the logic analyzer. For example, such information may be retrieved from the EDIF files associated with the device under test. Alternatively, a file providing a correspondence between each signal and the output pin to which it is applied may be stored either on a disk or in a memory location on the device under test. This file would be subsequently retrieved and used to map signal names to logic analyzer channels.

In step 514, the logic analyzer is prepped for measurements. For example, a deskew procedure may be invoked. The method ends thereafter in step 516.

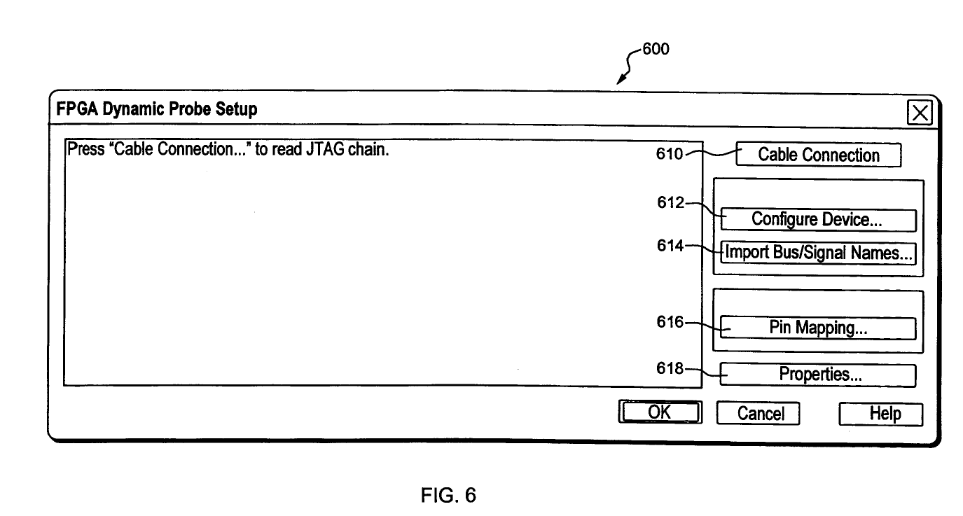

FIGS. 6 through 13 illustrate graphical displays associated with software capable of implementing the method described in FIG. 5. FIG. 6 is a screen shot of a graphical display produced by software in accordance with a preferred embodiment of the present invention. The dynamic probe software is generally divided into two sections: a setup section and a bank selection section. The window 600 illustrated in FIG. 6 illustrates a graphical display associated with the setup function. The probe setup window 600 has five buttons: cable connection 610; configure device 612; import bus/signal names 614; pin mapping 616; and properties 618. To start the setup process, a communication cable, such as a JTAG compliant cable, is initialized by activating the button 610.

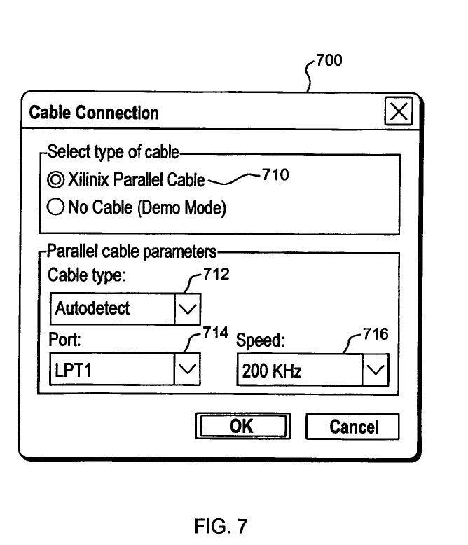

FIG. 7 is a screen shot of a graphical display related to the cable connection button 610 shown in FIG. 6. Referring to the dynamic probe 100 shown in FIG. 1, connection to each core 104 requires configuring a programming cable such as a JTAG compatible cable available from XILINX. The cable connection window 700 facilitates the acquisition of information necessary to configure a JTAG connection. A type of cable is obtained from the radio button section 710. In the shown example, the only cable type selectable is a XILINX parallel cable. Those of ordinary skill in the art will recognize that other cable types are available and may be used with the present invention. Pull down menu 712 allows the user to enter a cable type. Some examples of cable type include Xilinx Parallel 4 programming cable. The example shows an auto detection procedure that attempts to interrogate a cable and determine a type. The pull down menu 714 allows the user to provide a port to which the cable is connected, e.g. LPT1, LPT2, COM1, COM2, etc. . . . Finally the pull down menu 716 allows the user to input the speed of communication with the cable. In this example 200 KHz is selected. Once this information has been gathered, the software can initialize the necessary parameters for communication with the cable.

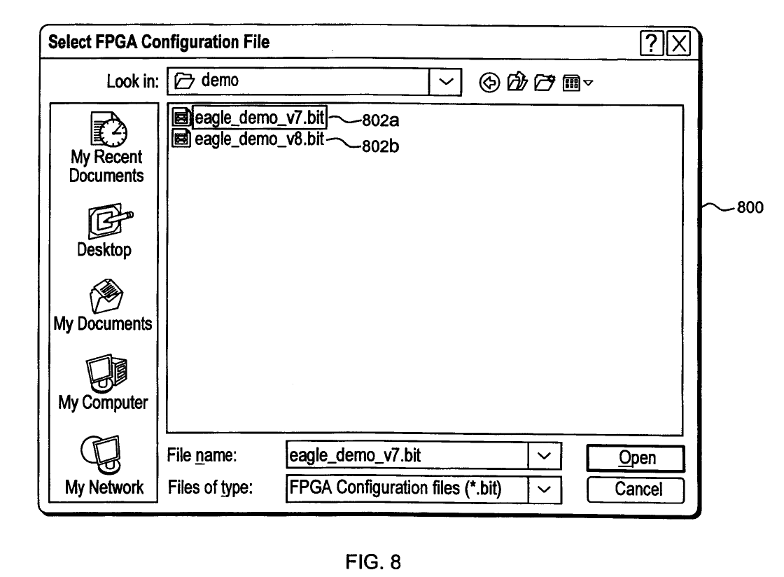

FIG. 8 is a screen shot of a graphical display related to the configure device button 612 shown in FIG. 6. The configure device button 612 brings up a file selection window 800 that permits the selection of a configuration file 802n. A configuration file 802n generally contains information to configure the FPGA to a state defined by a user. This file is created using FPGA design tools and is not normally humanly consumable.

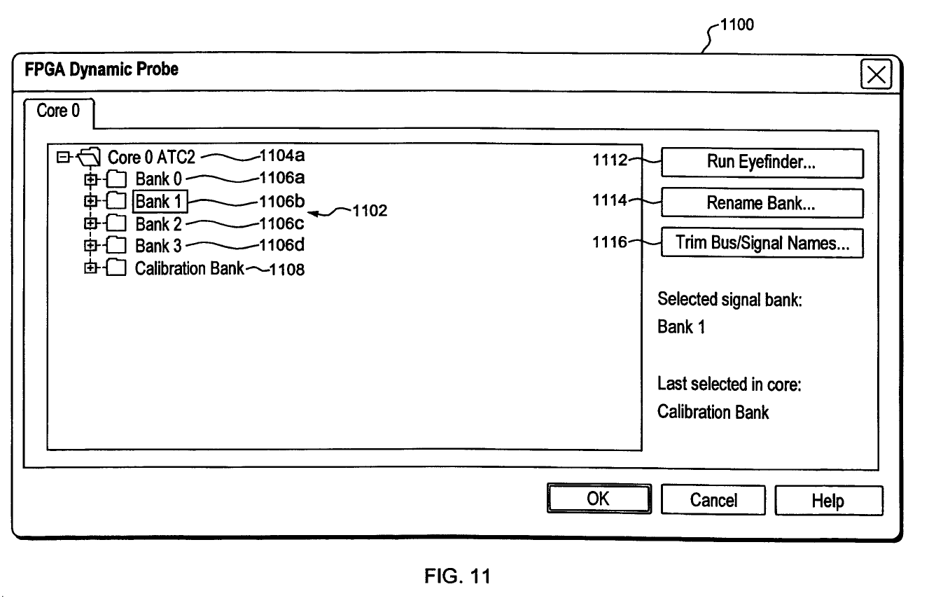

Once configured, the user can program the FPGA using the JTAG connection. After programming, the FPGA can be interrogated to identify the presence of any cores. Each identified core is then interrogated to retrieve core parameters from the core registries. These parameters may, for example, include a number of trace data pins and a number of signal banks. Using this information, the logic analyzer can create a display of the devices on the JTAG scan chain, including the cores inside the FPGA. Once the core is selected (see FIG. 11), the user then goes through a process called pin mapping initiated by the clicking on the pin mapping button 616. Pin mapping takes core data channels and clock channels and maps them to channels on the logic analyzer.

Signal importation, invoked using button 614, provides the mechanism for importing signal names referenced in a CDC file associated with the selected core for use in pin mapping. This process takes the signal names that were connected to the input core mux banks during core insertion and uses them as labels for the logic analyzer channels. This allows the user to see the exact name seen in the EDIF file on the screen of the logic analyzer. When the user switches banks, a new set of signal names will change, to reflect the next bank signals. While not necessary, importing the signal names improves the ease of use of the logic analyzer and simplifies measurement setup. Signal importation generally comprises retrieving the signal names from a specified location. For example, the specified location may be determined by parsing a .cdc file to identify another file (typically an EDIF file) on a storage device, such as a hard disc or optical disc. Alternatively, a chart containing signal names may be stored on the circuit or device under test itself. In any event, the signal names are extracted from the specified location and associated with each bank in a data structure local to the logic analyzer.

As noted, EDIF files provide a convenient location from which to obtain signal names. EDIF, one of the world's most widely used electronic design interchange formats, was originally part of the Electronic Industries Alliance's (EIA) service to the electronics industry. The following description was obtained from: http://www.edif.org/introduction.html. The Electronic Design Interchange Format (EDIF) is a format used to exchange design data between different CAD systems, and between CAD systems and Printed Circuit fabrication and assembly. The ‘Electronic’ refers to the type of data, i.e. design data for electronic systems and not the mechanism of interchange. Of course, an EDIF file is machine readable and may be interchanged electronically. Such CAD systems are often referred to as Electronic CAD (ECAD) systems or Electronic Design Automation (EDA) Systems. The EDIF format is designed to be written and read by computer programs that are constituent parts of EDA systems or tools, or by software that is part of front end manufacturing systems (CAM stations). Its syntax has been designed for easy machine parsing and is similar to LISP. By their very nature, the EDIF standards are behind the scenes for most EDA users. The development of EDIF has involved input from EDA vendors, designers and large user companies. Software to check conformance to the standard is available to help ensure that EDIF exchanges are as effective as possible. The format was standardized initially by the Electronic Industries Alliance (the EIA), a US based industry association, responsible for a number of electronics related standards. (Some familiar ones may be JEDEC and RS-232). Both EDIF Version 3 0 0 and EDIF Version 4 0 0 are ANSI standards and also IEC standards. EDIF Version 3 0 0 is formally IEC 61690-1; EDIF Version 4 0 0 is formally IEC 61690-2. Both standards have also been ratified as European Standards. EDIF Version 3 0 0 is EN 61690-1 and EDIF Version 4 0 0 is EN 61690-2.

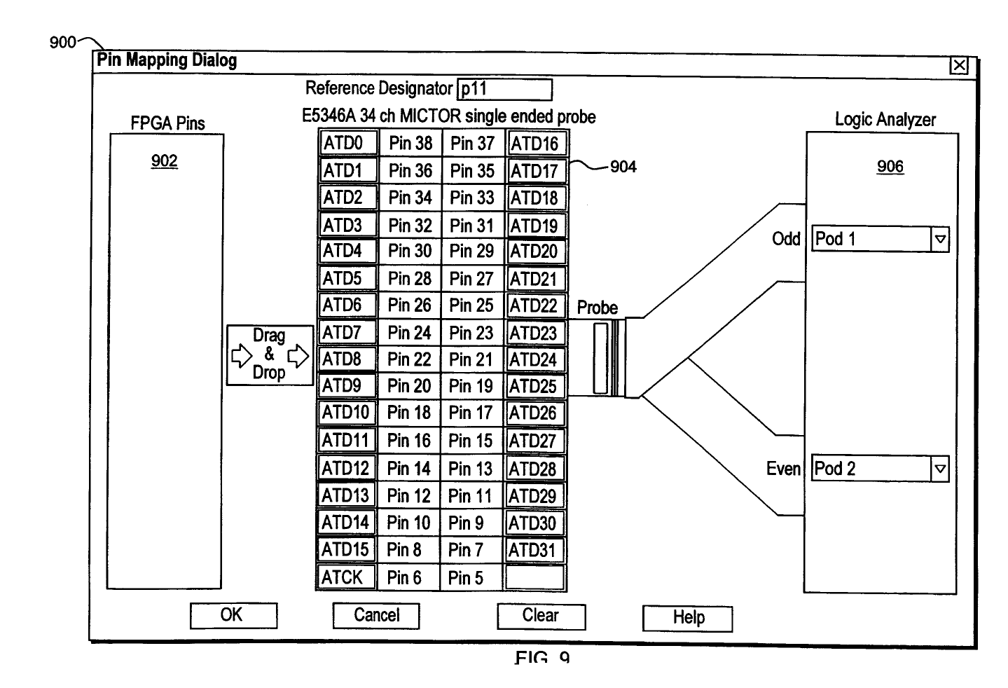

FIG. 9 is a screen shot of a graphical display 800 related to the pin-mapping button 616 shown in FIG. 6. Based on the core parameters retrieved from the core 104, the pin mapping routine generates a list 902 of FPGA pins. If the signal names have been imported, these names may be displayed for association instead of the generic pin names. A graphical representation 904 of the probe connector is also generated. In the example shown in FIG. 8, the probe connector is a 34 channel MICTOR single ended probe having pins 6 though 38. Pin mapping is performed by dragging pins designators (or signal names if imported) onto a text filed associated with a probe pin. In this example, the core data channels have pin names ATD followed by a number while the clock channel has the pin name ATCK. The graphical display 900 also creates a display 906 of the pods available on the logic analyzer.

After pin mapping, the logic analyzer's channels are configured. More specifically, the logic analyzer's channels are set to the core 104's output standard and the type of measurement, e.g. state or timing. For example, in the case of a state core with TDM, the logic analyzer is set to sample on both the rising and falling edge of the clock. Finally after pin mapping, the trace core and its outputs are enabled. The user can now take measurements, using the default bank, e.g. bank 0.

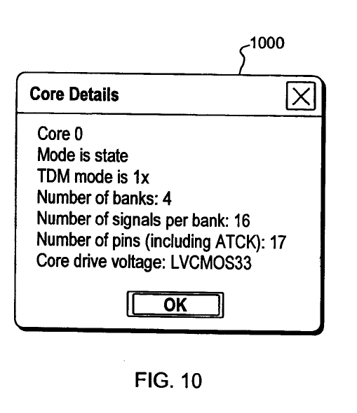

FIG. 10 is a screen shot of a graphical display related to the properties button 618 shown in FIG. 6. The properties button 618 causes the display of a window 1000 that provides information about a selected core, including for example the number of banks, pins, and signals per bank.

FIG. 11 is a screen shot of a graphical display associated with the selection of cores and banks. The bank selection section of the dynamic probe software allows a user to select a core and a bank for measuring, calibrate the logic analyzer for the selected bank and perform some housekeeping functions. When called the bank selection section generates a window 1100. The main focus of the window 1100 is the presentation of a tree diagram 1102 displaying the available cores 1104n and banks 1106n, including any available calibration banks 1108 (in the case of a state trace core). Selection is performed by simply clicking on a desired bank and clicking OK. The window 1100 also provides several buttons: an eyefinder button 1112; a rename button 1114; and a trim bus/signal name button 1116.

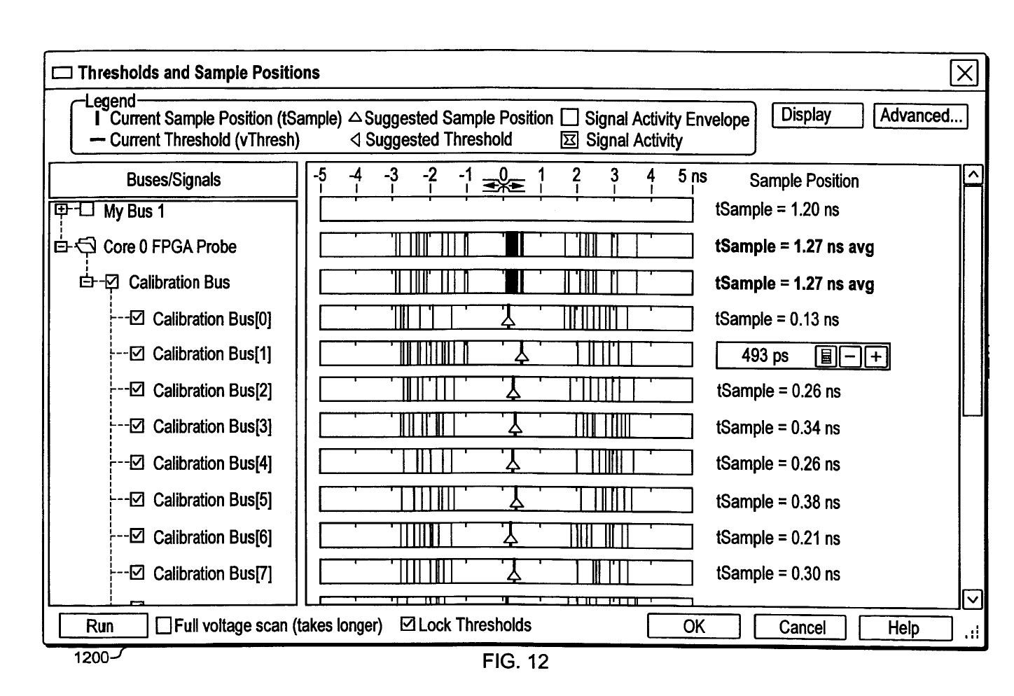

FIG. 12 is a screen shot of a graphical display related to the run eyefinder button 1112 shown in FIG. 11. Core calibration using the logic analyzer's eye finder function may be performed for state cores to ensure that state data captured by the logic analyzer is accurate. The thresholds and sample position window 1200 is one example of a calibration function useful in the context of the present invention. Using test data, the logic analyzer's input sampling circuitry adjusts the sampling position on a channel-by-channel basis. Using this adjustment it is possible to align all input channels so that the data is perfectly aligned and sampled by the input trace core clock.

In state cores, the core calibration bank produces a 5A-A5 pattern on the trace core pins when selected. This pattern can then be used to calibrate the logic analyzer. The calibration operation, or data deskew, is performed, for example, using the logic analyzer's eye finder tool. Eye finder is a software feature that steps through the different sampling positions per data acquisition channel. As it progresses through each position it detects valid, stable data and builds up a window of valid sampling positions. Once it completes this process it computes the center of valid sampling window and then displays the results its finds. From the display the user can see the results and also manually adjust these settings, if necessary. The core calibration bank can be used as the stimulus for eye finder, but it is not the only data source that can be used for data deskew. The user can also use any bank to perform this calibration. They do this by selecting any bank and then running eye finder, as mentioned. One reason for calibrating with specific bank data is that it may have random toggling patterns that accentuate board noise effects. In this case, the bank pattern is better stimulus for data deskew, since it will cancel out all the unstable sampling points affected by board noise effects. However if the user banks do not generate toggling data on every channel then the core calibration bank should be used for data deskew.

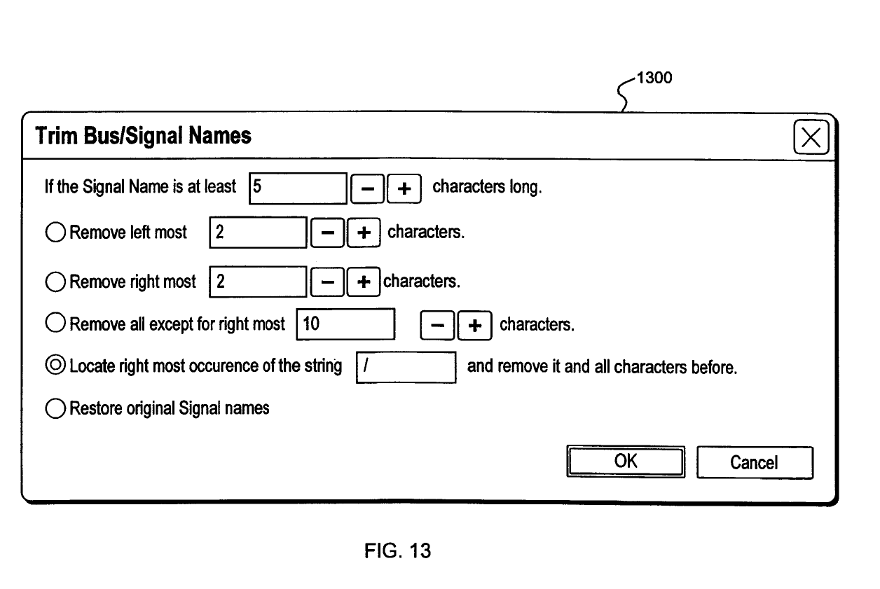

FIG. 13 is a screenshot of a graphical display 1300 related to the trim bus/signal names 1116 shown in FIG. 11. The trim window 1300 permits the user to apply trimming rules to the names of busses and signals. A variety of formatting rules may be implemented with several being illustrated by the contents of the window 1300.

Tickle Functionality

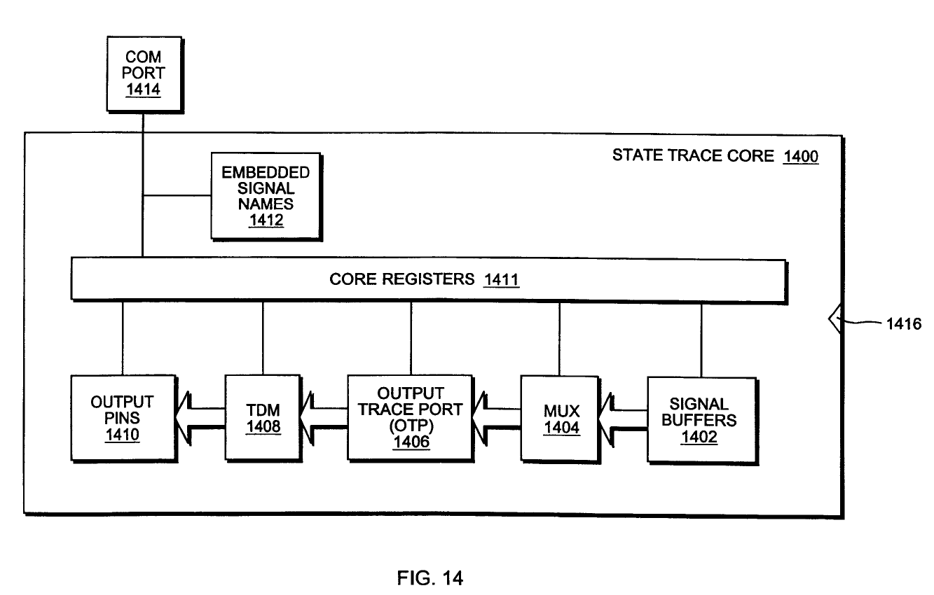

FIG. 14 is a block diagram of a state trace core 1400 (also referred to as the core 1400), for use in a dynamic probe 100, in accordance with an embodiment of the present invention. The core 1400 generally comprises a multiplexer 1404 that receives signals from signal buffers 1402, an off-chip trace port (OTP) 1406, a time division multiplexer (TDM) 1408, output pins 1410, along with a set of status and control registers collectively referred to as the core registers 1413. The core registers 1413 provide supervisory access to a logic analyzer, such as the logic analyzer 110. The buffers 1402, mux 1404, OTP 1406, TDM 1408 and output pins 1410 provide the physical link between probed signals and the logic analyzer 110 (see FIG. 1). The physical link is synchronized to a sampling clock 1416. A corn port 1414 provides access, for the logic analyzer, to the core registers 1411 and a storage area 1412 that stores information associating output pins with signal names and banks.

In general, the state trace core 1400 is similar to the state trace core 200 shown in FIG. 2 with the addition of the OTP 1406. The OTP 1406 has a mux that switches in signals, from one or more registers, referred to herein as pin-wiggle registers, in the core registers 1411, used to automate core setup. The pin-wiggle registers facilitate the placing of a high logic signal onto one or more selected output pin(s) 1410n. In the case of the state core 1400, the signal generated based on the pin-wiggle registers are muxed with the deskew data generator. Using the OTP 1406, a connected logic analyzer can generate a signal on a specified output pin 1410n and by monitoring the output pins, the logic analyzer can identify the input channel associated with the output pin 1410n.

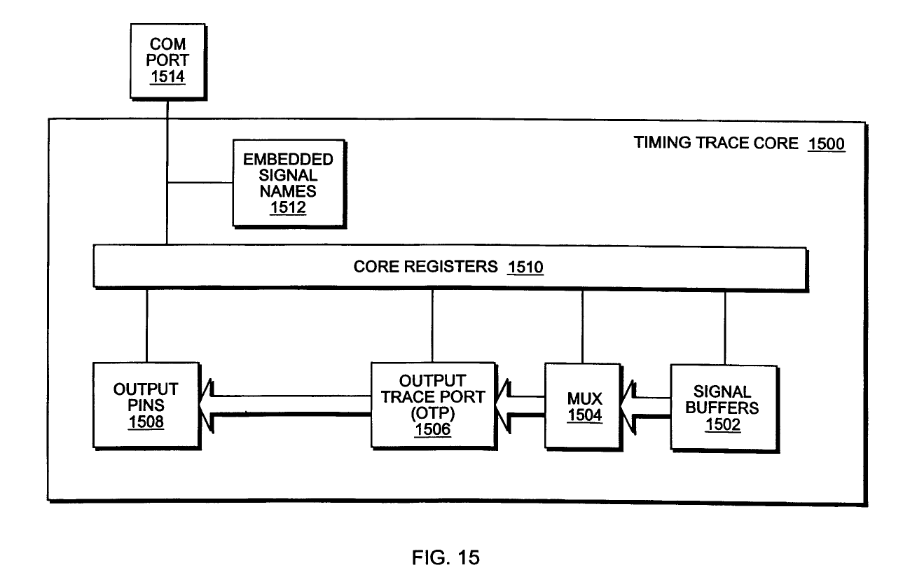

FIG. 15 is a block diagram of a timing trace core 1500 (also referred to as the core 1500), for use in a dynamic probe, in accordance with an embodiment of the present invention. The core 1500 generally comprises a multiplexer 1504 that receives signals from signal buffers 1502, an off-chip trace port (OTP) 1506, output pins 1508, and core registers 1510. As with the timing trace core 300, the signal path is asynchronous inside the core 1500 and does not require a sampling clock. Data is captured using the logic analyzer's high speed sample clock. A corn port 1514 provides access, for the logic analyzer, to the core registers 1410 and a storage area 1512 that stores information associating output pins with signal names and banks.

In general the timing trace core 1500 is similar to the timing trace core 300 shown in FIG. 3 with the addition of the OTP 1506. The OTP 1506 has a mux that switches in signals, from one or more registers, referred to herein as pin-wiggle registers, in the core registers 1510, used to automate core setup. The pin-wiggle registers facilitate the placing of a high logic signal onto one or more selected output pin(s) 1508n. In the case of the timing core 1500, the pin wiggle registers are muxed with the output put of the mux bank. Using the OTP 1506, a connected logic analyzer can generate a signal on a specified output pin 1508n and by monitoring the output pins, the logic analyzer can identify the input channel associated with the output pin 1508n.

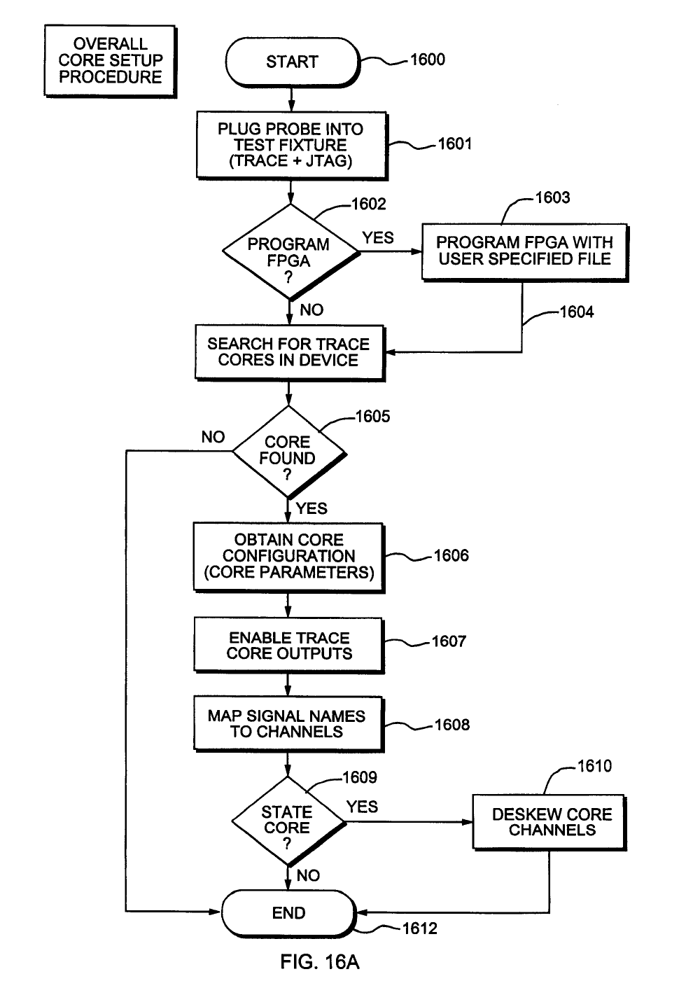

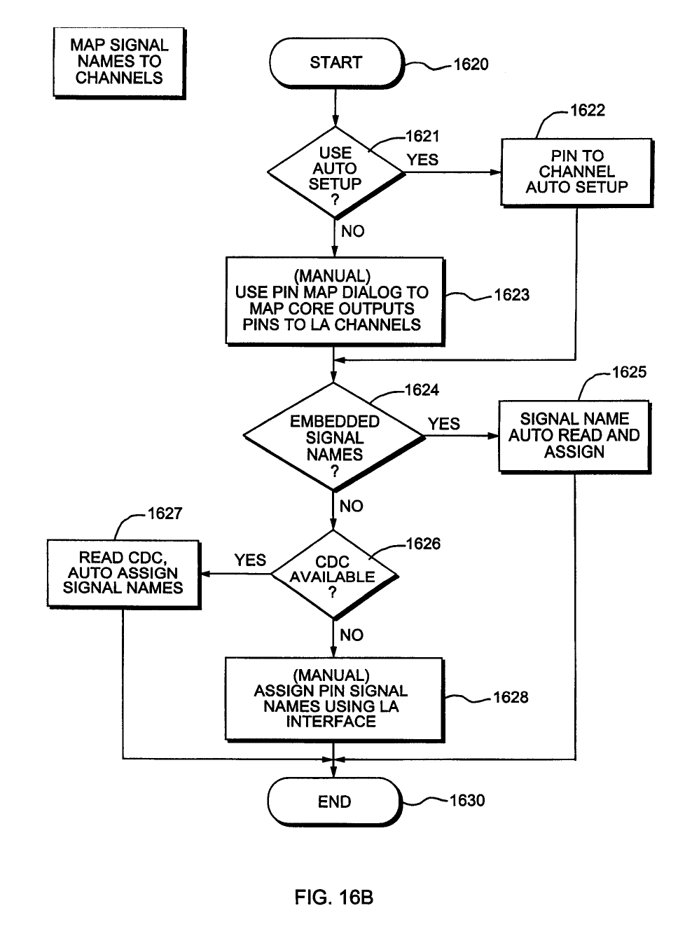

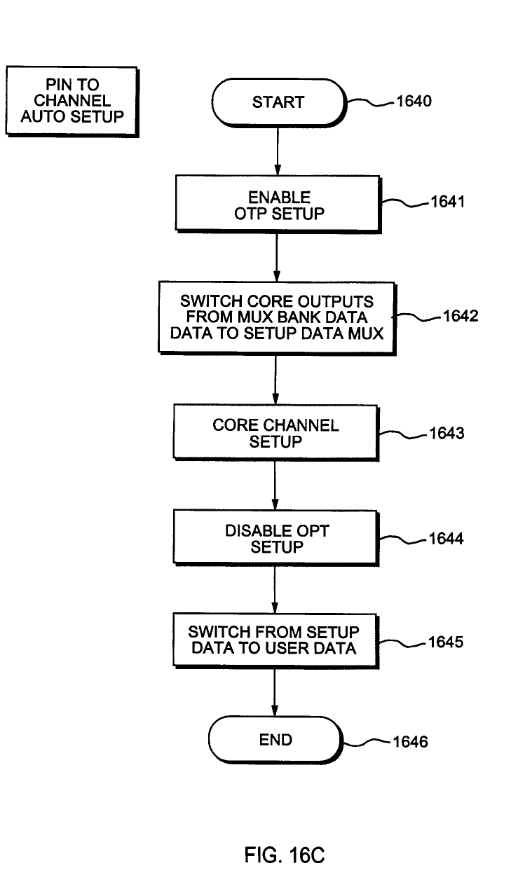

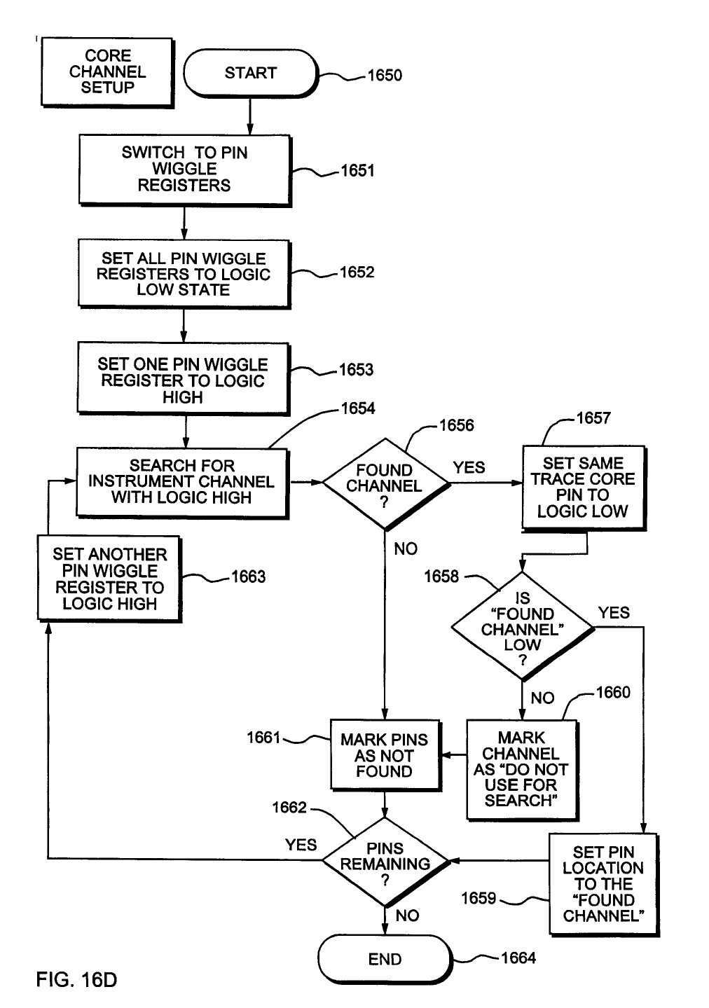

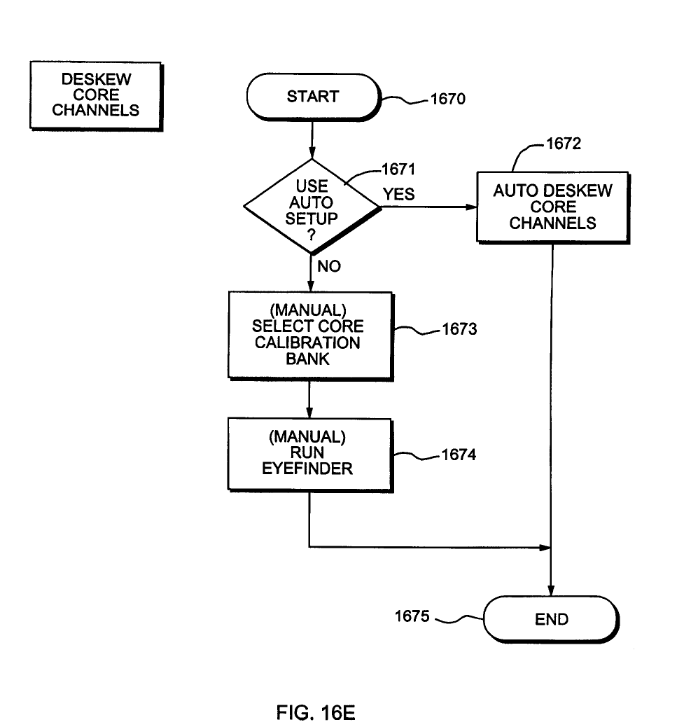

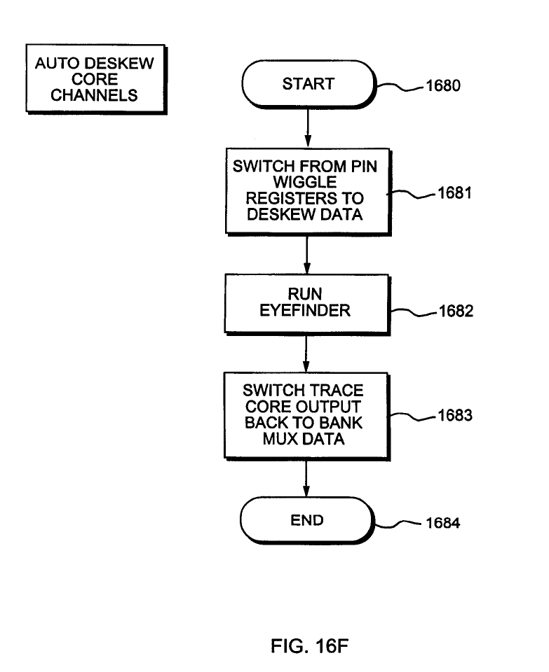

FIGS. 16a through 16f are flow charts describing a method of preparing a logic analyzer for a test session using pin-wiggle registers. To facilitate automated setup, a mapping of each signal name in each bank to an output pin may be stored be stored on the circuit or device under test itself, e.g. ASIC or FPGA. Additional configuration such as the output signal standards (e.g. LVTTL, LVDS, and SSTL) and configuration (e.g. type of connector) including the number and layout of the output pins may also be stored on the device under test. This allows the logic analyzer 400 to retrieve information for pin mapping directly from the device under test. During setup, the logic analyzer outputs a test signal on a selected output pin on the device under test. The logic analyzer then associates the selected output pin with the probe input pin upon which activity is seen.

The method starts in step 1600 in FIG. 16a. In step 1601, the test engineer turns on the test equipment, e.g. a logic analyzer, connects the JTAG cable, and plugs a test fixture (i.e. a mictor, soft touch, samtec, or flying lead probes are examples) into the test points on the device under test, such as into a PC board supporting an ASIC or FPGA.

Next, in step 1602, a determination is made as to whether the FPGA needs to be programmed. If YES, the FPGA is programmed with a user specified file in step 1603. In either event, the method now proceeds to step 1604 and a search is conducted for a trace core in the device under test.

In step 1605 a determination is made as to whether a core was found. If no core is found the method ends in step 1612. If, in step 1605, a core was found, the method proceeds to step 1606 wherein core configuration parameters are retrieved. The core configuration parameters may be retrieved via the corn parts 1414 or 1514. The core configuration parameters generally comprise information about the core, e.g. the type of core, the number of banks, the number of signals per bank. The core configuration parameters may also comprise information obtained from the storage locations 1412 or 1512 including a listing of signal names and corresponding bank and output pin for each signal. Next, in step 1607, the trace core outputs are enabled. Trace core outputs may be enabled through the corn port by setting an output enable register connected to the trace core output buffers. Prior to being enabled the outputs are “off”. That is these outputs are in a tri-state, in-active mode. In step 1608, signal names are mapped to their respective channels as described in FIG. 16b.

In step 1609, a determination is made as to whether the core is a state core, e.g. as shown in FIG. 14. If the core is a state core, the method proceed to step 1610 and the core channels are deskewed as described in FIG. 16e. Once deskewing has been performed, the method ends in step 1612. If in step 1609, the core was other than a state core, e.g. a timing core, deskewing must be performed manually and the method ends without automatic deskewing in step 1612.

FIG. 16b is a flowchart explaining a method for mapping signal names to channels corresponding to step 1608 in FIG. 16a. The method starts in step 1620. In step 1621, a check is made to determine whether the pin to channel correspondence is to be automatically performed. This determination may be made by the user or based on whether the device under test has the capability to output a test signal (“wiggle”) on a selected output pin. If the pin to channel correspondence is to be automatically performed, the method goes to step 1622 and an auto setup procedure, described with respect to FIG. 16c, is performed. If the pin to channel correspondence is to be manually performed, the method proceeds to step 1623 and the user performs a manual pin mapping, using for example the graphical display shown in FIG. 9. In either event, the method then moves to step 1624.

In step 1624, a determination is made as to whether signal names are embedded in the device under test, for example in storage locations 1412 or 1512. If the signal names are embedded, they are read out in step 16254 and assigned to the corresponding channels. Thereafter, the method ends in step 1630 (with a return to step 1609 in FIG. 16a).

If in step 1624, the signal names are not embedded, the method proceeds to step 1626 and a determination is made as to whether a CDC file is available. If a CDC file is available, the method proceeds to step 1627 and the CDC file is retrieved, signal names extracted and assigned to the corresponding channels. Thereafter, the method ends in step 1630 (with a return to step 1609 in FIG. 16a).

If in step 1626, a CDC file is not available, the method proceeds to step 1628 and the user manually assigns pin signal names using the logic analyzer's interface. Thereafter, the method ends in step 1630 (with a return to step 1609 in FIG. 16a).

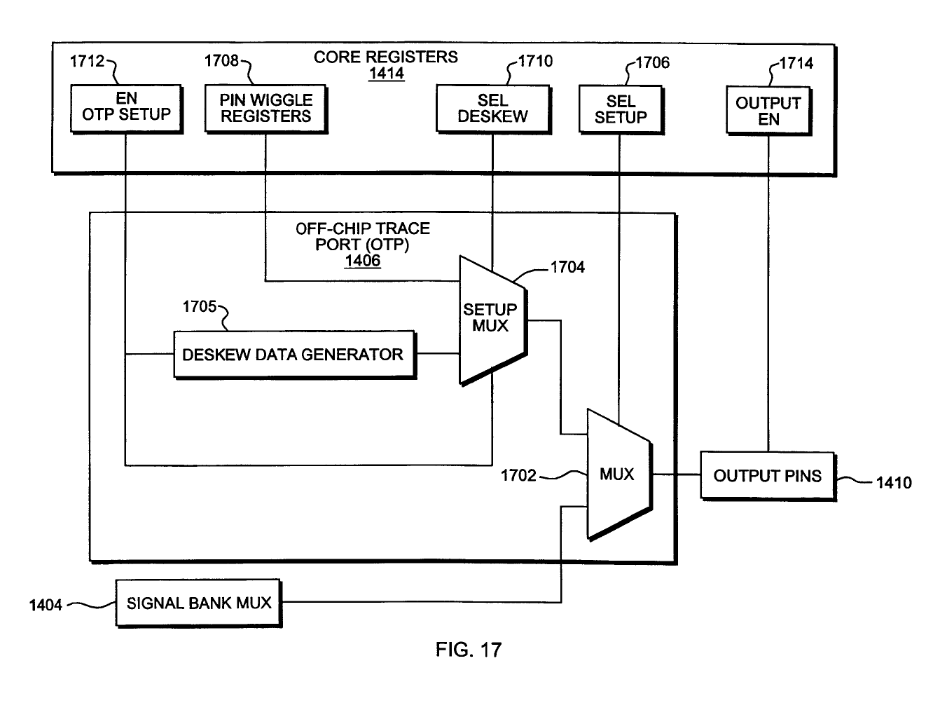

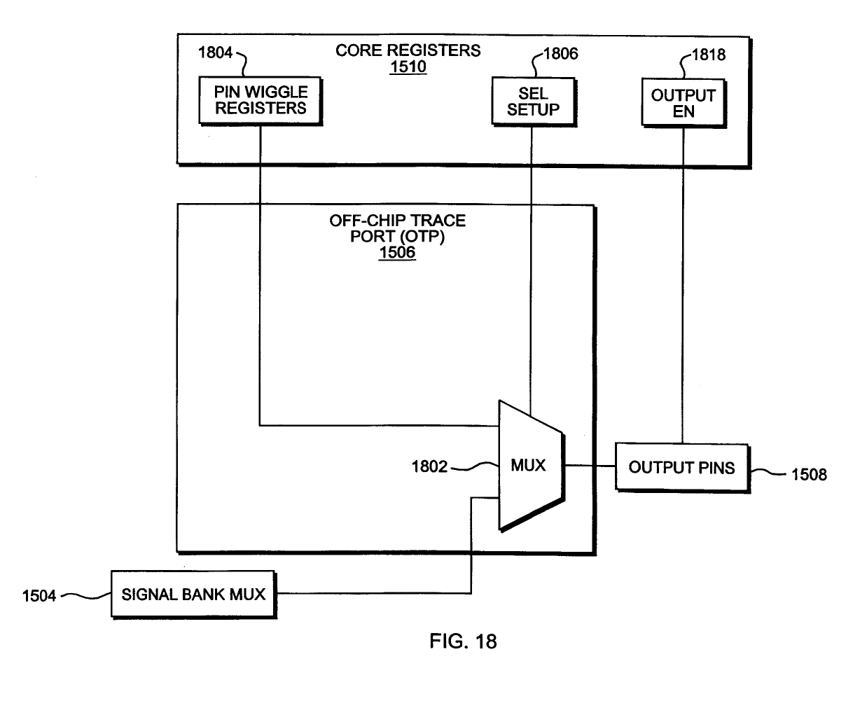

FIG. 16c is a flowchart explaining a method for pin to channel auto setup corresponding to step 1622 in FIG. 16b. The method starts in step 1640. In step 1641, the output trace port is enabled by setting an associated register in the core registers. Prior to this the circuit is off, or in sleep mode. Next in step 1642, the output pins are configured to output setup data. This will be more fully discussed with respect to FIGS. 17 and 18; however, this generally involves switching the output of one or more multiplexers to pass through a test signal.

Next in step 1643, a core channel setup, described with respect to FIG. 16d, is performed. In step 1644, the output trace port is disabled by clearing the associated register in the core registers. In step 1645, the output pins are configured to output the signals to be monitored from the device under test. Thereafter, the method ends in step 1646 (with a return to step 1624 in FIG. 16b).

FIG. 16d is a flowchart explaining a method for core channel setup corresponding to step 1643 in FIG. 16c. The method starts in step 1650. In step 1651, the output pins are configured to output wiggle data. This will be more fully discussed with respect to FIGS. 17 and 18; however, this generally involves switching the output of one or more multiplexers to pass through a test signal based on a set of registers, the pin wiggle registers, in the core registers. In step 1652, all the bits in the pin-wiggle registers are set to a logical low state. Next in step 1653, one register in the pin wiggle registers is set to a logical high. Generally, each bit in the pin wiggle registers corresponds to an output pin—accordingly at this point one output pin should have a high logical state. In step 1654, the channels on the logic analyzer are searched to identify a channel displaying logic high. In step 1656, a determination is made as to whether such a channel was found.

If, in step 1656, a channel was found with a logic high signal, the method proceeds to step 1657 and the register is set to a logical low so as to ouput a low logic signal on the output pin. A determination is made in step 1658 as to whether the found channel now displays a logical low. If the found channel displays a logical low, the method proceeds to step 1659 and the ouput pin is identified as the found channel and the correspondence is saved in the logic analyzer. Next, a determination is made in step 1662 as to whether there are additional pins remaining. If YES, the method goes to step 1663, another wiggle register is set to logical high and the method returns to step 1654.

If in step 1658, the found channel does not go to low, the method proceeds to step 1660 and the channel is marked as do not use. Next, in step 1661, the pin is marked as not found in the logic analyzer and the method proceeds to step 1662 for a check as to whether there are additional pins.

If in step 1665, no channels were found to have a high logic level, the output pin corresponding to the wiggle register is marked as not found in the logic analyzer and the method proceeds to step 1662 for a check as to whether there are additional pins. If, in step 1662, there are no more pins, the method ends in step 1664 (with a return to step 1644 in FIG. 16c).

FIG. 16e is a flowchart explaining a method for deskewing channels corresponding to step 1610 in FIG. 16a. The method starts in step 1670. In step 1671, a determination is made as to whether an automatic deskewing process is to be used. This determination may be made by the user or may be made automatically based on the presence of a core, such as a state trace core with the ability to generate test signals. If, in step 1671, a determination is made to conduct an auto deskew, the method proceeds to step 1672 and an auto deskew method, described in FIG. 16f, is executed. Thereafter, the method ends in step 1675 (with a return to step 1612 in FIG. 16a).

If a manual deskewing process is desired in step 1671, the method proceeds to step 1673. In step 1673, a bank is selected for core calibration. In step 1674, a calibration procedure, such as an eye finder, is executed on the logic analyzer. Thereafter, the method ends in step 1675 (with a return to step 1612 in FIG. 16a).

FIG. 16f is a flowchart explaining a method for the auto deskewing of core channels corresponding to step 1672 in FIG. 16e. The method starts in step 1680. In step 1681, the output of the core is set to deskew data. This will be more fully discussed with respect to FIGS. 17 and 18; however, this generally involves switching the output of one or more multiplexers to pass through a test signal suitable for a deskewing operation. Next, in step 1682, a deskewing procedure, such as an eye finder, is executed on the logic analyzer. In step 1683, the output pins are configured to output the signals to be monitored from the device under test. Thereafter, the method ends in step 1684(with a return to step 1675 in FIG. 16e).

FIG. 17 is a block diagram useful for explaining the operation of an off-chip trace port in a state trace core according to an embodiment of the present invention. The Off-chip Trace Port 1406 generally comprises a bank multiplexer 1702 that switches between a bank of signals outputted by a setup bank multiplexer 1704 and the signal bank multiplexer 1404 based upon the state of a register 1706 in the core registers 1411. The setup multiplexer 1704 switches between a bank of signals outputted by a deskew data generator 1706 and the pin wiggle registers 1708 based on the state of the register 1710. Thus, the output of the multiplexer 1702 will be one of the pin wiggle registers 1708, deskew data from the deskew data generator 1706, or the output of the signal bank multiplexer 1404.

The operation of the deskew data generator 1706 is described in U.S. patent application Ser. No. 10/923,460. Deskew operation is enabled by register 1712 which also enables operation of the setup multiplexer 1704. Thus by setting the register 1712 to low, the deskew data generator 1705 and the setup multiplexer 1704 are deactivated thereby reducing the power load of the core. Similarly register 1714 is used to disable output pins 1410.

The pin wiggle registers 1708 comprises a series of registers equal in width to the number of output pins. When the setup mux 1704 is enabled (by the register 1712) and set (by the register 1710) to output from the pin wiggle registers 1708, the setup mux 1704 outputs a high logic signal on any pin in the set of output pins 1410 for which the corresponding bit in the pin wiggle registers is set.

FIG. 18 is a block diagram useful for explaining the operation of an off-chip trace port in a timing trace core according to an embodiment of the present invention. The Off-chip Trace Port 1506 generally comprises a bank multiplexer 1802 that switches, based on a register 1806 in the core registers 1510, between pin wiggle registers 1804 and the signal bank multiplexer 1404. Register 1510 is used to disable output pins 1508. The pin wiggle registers 1804 comprise a series of registers equal in width to the number of output pins. When the mux 1802 is set, by register 1806, to output from the pin wiggle registers 1804, the mux 1802 outputs a high logic signal on any pin of the output pins 1508 for which the corresponding bit in the pin wiggle registers is set.

1. A method for setting up a test instrument to perform measurements on a circuit having a plurality of signal applied to a plurality of output pins, the method comprising:
retrieving configuration parameters regarding the output pins, the configuration parameters including an identification of the output pins;
configuring the test instrument to interface with the output pins based on the configuration parameters;
graphically displaying on a screen associated with the test instrument the list of output pins and a list of input lines associated with the test instrument; and
allowing a user to associate, on the graphical display, each output pins with an input line to which each output pin is connected.

2. A method, as set forth in claim 1, further comprising:
retrieving a list of signal identifiers identifying signals within the circuit correlated with the output pins to which they are applied; and
identifying measurements displayed on the test instrument with the with an associated signal identifier.

3. A method for setting up a test instrument to perform measurements on a circuit having a plurality of signal applied to a plurality of output pins, the method comprising:
connecting the test instrument to the circuit;
transmitting, from the circuit to the test instrument, configuration parameters regarding the output pins, the configuration parameters including an identification of the output pins;
configuring the test instrument to interface with the output pins based on the configuration parameters;
sending a signal from the test instrument to the circuit instructing the circuit to output a test signal on a selected output pin; and
identifying within the test instrument which channel receives the test signal and associating the identified channel with the selected output pin.

4. A method, as set forth in claim 3, further comprising:
retrieving a list of signal identifiers identifying signals within the circuit correlated with the output pins to which they are applied; and
identifying measurements displayed on the test instrument with the with an associated signal identifier.

5. A method, as set forth in claim 3, wherein the step of connecting the test instrument to the circuit comprises:
connecting a probe to the output pins; and
connecting a port on the test instrument to a port on the circuit so as to permit the test instrument to read and write registers on the circuit.

6. A method, as set forth in claim 5, wherein the step of connecting a port on the test instrument to a port on the circuit comprises establishing a JTAG compliant communication link between the test instrument and the circuit.

7. A method, as set forth in claim 5, wherein the step of transmitting, from the circuit to the test instrument, configuration parameters comprises reading registers in the circuit containing the configuration parameters.

8. A method, as set forth in claim 5, wherein the configuration parameters comprise an identification of the cores that are available for interrogation, the number of pins used by the core, and the output standard of the output pins.

9. A method, as set forth in claim 5, wherein the step of sending a signal from the test instrument to the circuit instructing the circuit to output a test signal on a selected output pin comprises:
setting a bit of a wiggle register, representing the output pins on the circuit, to a high logic level; and
setting a register to cause a multiplexer in the circuit to output the contents of the wiggle register onto the output pins.

10. A method, as set forth in claim 9, wherein the step of identifying within the test instrument which channel receives the test signal comprises:
identifying the channel on the test instrument for a channel with a high logic level;
setting the bit in the wiggle register to a low logic level; and
if the identified channel goes to a low logic level, associating the identified channel with the selected output pin.

11. A method of configuring a logic analyzer to test an FPGA, the method comprising:
sending an instruction from the logic analyzer to the FPGA instructing the FPGA to output a high logic level on a selected output pin;
scanning input channels on the logic analyzer to identify which input channel exhibits a high logic level;
mapping, within the logic analyzer, the identified input channel with the selected output pin; and
repeating steps 1 through 3 with different selected output pins until each output pin has been mapped to a channel.

12. A method, as set forth in claim 11, further comprising:
electronically retrieving information relating output pins on the FPGA to names of signals applied to the output pins; and
mapping, within the logic analyzer, the input channels to the names of the signals received by the channels.

13. A method, as set forth in claim 12, wherein the FPGA is configured to selectively output multiple banks of signals onto the output pins, the step of mapping, within the logic analyzer, the input channels to the names of the signals received by the channels further comprising:
mapping, within the logic analyzer, the input channels to the names of the signals received by the channels based on the bank to which the signal belongs.

14. A method, as set forth in claim 11, wherein the step of sending an instruction comprises:
sending an instruction to the FPGA causing a multiplexer to output the contents of a wiggle register, the wiggle register having a width equal to the number of output pins; and
sending an instruction to set a selected bit the wiggle register.

15. A test instrument comprising:
a processor responsive to software;
a display;
a probe that delivers a plurality of channels for testing;
software that causes the processor to:
configure the test instrument to interface with a device under test;
obtain from the device under test configuration information regarding output pins on the device under test;
graphically display on the display a list of output pins on the device under test and a list of channels; and
allow a user to associate, on the display, each output pin with a channel upon which the signals from the output pin are received by the test instrument.

16. A test instrument, as set forth in claim 15, further comprising:
a serial communication channel adapted to interface with the device under test and over which the configuration information is transmitted.

17. A test instrument, as set forth in claim 16, wherein the serial communication channel comprises a JTAG compliant cable.

18. A test instrument, as set forth in claim 15, wherein the software further causes the processor to:
retrieve a list of signal identifiers identifying signals within the device under test correlated with the output pins to which they are applied; and
identify measurements on the display with the with an associated signal identifier.

19. A test instrument, as set forth in claim 15, wherein the software further causes the processor to:
direct the circuit under test to place a test signal on a designated output pin;
identify the channel upon which the test signal is received; and
correlate the designated output pin with the identified channel.

20. A test instrument, as set forth in claim 15, wherein the software further causes the processor to:
retrieve a file giving a correspondence between the output pins and the names of signals applied to the output pins.

21. A test instrument, as set forth in claim 20, wherein the file is retrieved from the device under test.

22. A test instrument, as set forth in claim 20, wherein the file is retrieved based on information in a EDIF file associated with the device under test.

23. A test system comprising:
an FPGA having:
a plurality of output pins dedicated for debugging;
a set of control registers that include data describing the plurality of output pins and data that affects the operation of the output pins;
a first interface for sending and receiving configuration data including instructions that affects the contents of the control registers;
a logic analyzer having:
a processor responsive to software;
a display;
a probe that delivers a plurality of channels for testing;
software that causes the processor to:
configure the logic analyzer to interface with the FPGA;
obtain from the control registers configuration information regarding the output pins on the FPGA;
graphically display on the display a list of output pins on the FPGA and a list of channels; and
allow a user to associate, on the display, each output pin with a channel upon which the signals from the output pin are received by the logic analyzer.

24. A test system, as set forth in claim 23, wherein the FPGA further comprises:
a multiplexer, responsive to the control registers, that switches the signals applied to the output pins between banks of signals.

25. A test system, as set forth in claim 23, wherein the FPGA further comprises:
signal name information correlating output pins with signal names.

26. A test system, as set forth in claim 25, wherein the logic analyzer further comprises:
software that causes the processor to retrieve the signal name information and display the signal name associated with each displayed channel.

27. A test system, as set forth in claim 23, wherein the FPGA further comprises a circuit adapted to output a test signal on a selected one of the output pins and wherein the logic analyzer further comprises software that causes the processor to identify the channel on which the test signal is received and automatically correlate the selected output pin with the identified channel.
